(19) United States
(12) Patent Application Publication
(10) Pub. No.: US 2010/0210496 A1
(43) Pub. Date: Aug. 19, 2010

(54) Fragrance Effect of Perfume Esters

(76) Inventors: Cornelius Bessler, Dusseldorf (DE); Andreas Bauer, Kaarst (DE); Wolfgang Lahn, Willich (DE); Andreas Gerigk, Erkelenz (DE); Hermann-Josef Welling, Monheim (DE)

Correspondence Address: Henkel Corporation, 10 Finderne Avenue, Bridgewater, NJ, 08807, US

(21) Appl. No.: 12/773,048

(22) Filed: May 4, 2010

Related U.S. Application Data
(63) Continuation of application No. PCT/EP08/63315, filed on Oct. 6, 2008.

(30) Foreign Application Priority Data
Nov. 8, 2007 (DE) 102007 053 615.3

(51) Int. Cl. C11D 3/50

(52) U.S. Cl. 510/107

(57) ABSTRACT

Adhesion of perfume esters to surfaces, such as the surfaces of textiles, of hard objects, or of the human body, was able to be improved. Said object is achieved substantially by using particular enzymes leading to improved fixing of the perfume ester on hard and/or soft surfaces.

### CROSS REFERENCE TO RELATED APPLICATIONS

The present application is a continuation of International Patent Application No. PCT/EP2008/063315 filed 6 Oct. 2008, which claims priority to German Patent Application No. 10 2007 053 615.3 filed 8 Nov. 2007.

The present invention relates to a process for fixing perfume esters onto hard and/or soft surfaces. The invention further relates to a method for fixing perfume esters to hard and/or soft surfaces when washing or cleaning using hydrolases (in particular hemicellulase, protease and/or amylase). Moreover, the invention relates to a method for prolonging/enhancing the fragrance effect of the perfume ester in perfume ester-containing washing or cleaning agents with the use of hydrolases (in particular hemicellulase, protease and/or amylase).

When washing textiles or cleaning hard surfaces such as bathroom tiles, one expects not only visually immaculate cleanliness, but also the absence of any unpleasant odors on the cleaned textiles or hard surfaces. Perfume fragrances originating from the cleaning agent, washing agent or laundry conditioner that provide a pleasant aroma are perceived as particularly agreeable and enhance the impression of cleanliness. For example, when hand-washing textiles, normally in a washbasin, many consumers perceive the remaining aroma in the basin and on the hands as agreeable. Consumers want laundered washing to have a fragrance that is not only on the product itself and still noticeable after the wash, but especially is also still clearly perceptible on the treated object over several days, ideally even weeks. However, the amount of perfume absorbed from the wash or rinse step out of the aqueous solution onto the textiles or other surface is frequently too little to also ensure a perceptible fragrance impression over a longer time. As perfumes are a particularly high cost component of washing and cleaning agents, it is preferred to use them only in low quantities. Loss of these ingredients (for example in a washing machine) is equally unsatisfactory for the manufacturer and the consumer of such agents.

Surprisingly, it has now been found that by adding certain enzymes, namely hydrolases, preferably chosen from a) glycosidases such as a1) hemicellulases, particularly preferably mannanase and/or, a2) starch-degrading enzymes, particularly preferably amylase and/or, b) proteases such as subtilases, especially subtilisins, the adhesion of perfume esters on a variety surfaces such as textiles, hard objects or on the skin can be improved if these enzymes are used together with perfume ester(s) when washing or cleaning the surfaces.

Based on this background, in one embodiment the present invention provides a process for fixing or adhering perfume esters to hard and/or soft surfaces, wherein the surface is treated at a temperature below 95° C. for a period of 1 minute to 300 minutes with an aqueous treatment liquor comprising perfume ester(s) and hydrolases(s). In a preferred embodiment of the invention, the hydrolase is chosen from
a) glycosidases, preferably
   a1) hemicellulases, particularly preferably mannanase and/or,
   a2) starch-degrading enzymes, particularly preferably amylase and/or,
b) proteases, preferably subtilases, especially subtilisins.
   Mannanase, protease and/or amylase are particularly preferably used.

It has been found that this process for treating hard and/or soft surfaces with an aqueous treatment liquor comprising perfume ester(s) and the previously cited enzyme(s) results in a “fixing” (i.e., an improved adhesion) of the perfume ester onto the treated hard and/or soft surfaces, resulting in a prolonged and enhanced fragrance effect of the perfume ester(s), especially on the dry surface. The fragrance linked to the perfume ester is not only perceptible on the product itself and immediately after washing, but remains clearly perceptible for a plurality of days, ideally even weeks after the washing or cleaning step or treatment step occurred. In other words, a better perceptible fragrance impression can be ensured on the treated surfaces for a longer time.

In this regard, inventively treated surfaces, especially textiles, after treatment and then preferably dried, smelled particularly intensively in an olfactory evaluation on the dried object seven (7) days after the treatment. Here, the improved fragrance impression is due to the perfume ester, whose fragrance emanates from the inventively treated surface, as attested by trained olfactory experts in an olfactory evaluation on the dried object seven (7) days after treatment.

Further, perfume compositions (e.g. perfume oils, meaning fragrant mixtures of at least two or more perfumes) benefit from the presence of the perfume ester so that the fragrance effect of other perfumes is prolonged, thereby prolonging the overall fragrance effect of the perfume ester-containing perfume composition. The prolonged overall fragrance effect or fragrance boost, especially on the dried object, is due to the existence of perfume ester in the perfume composition. Perfume esters are present in the total perfume composition in amounts of at least 1 wt. %, preferably at least 2 wt. % and especially at least 10 wt. %, based on total amount of the perfumes. This limit can also be higher, for example, at least 15 wt. %, 20 wt. %, 25 wt. %, 30 wt. %, 40 wt. % or 50 wt. %, wt. % based on total amount of the comprised perfumes. This limit can still be even higher, for example, at least 60 wt. %, 70 wt. %, 80 wt. % or 90 wt. %, wt. % being based on total amount of perfumes.

Soft surfaces in the context of this invention include skin, as well as hair and especially textiles of various compositions (e.g., cotton, wool, silk, polyester, polyamide, viscose and blended fabrics of any type). Hard surfaces include typical hard surfaces such as glass, metal, porcelain, ceramic and stoneware, especially in the household sector and sanitary sector (e.g., in the form of dishes, pots, plates, pans, floors, windows, tiles, flagstones etc.).

Preferred perfume compounds employed as the perfume esters include 3a,4,5,6,7,7a-hexahydro-4,7-methano-1H-indenyl acetate, tricyclo-5.2.1.02,6]dec-4-en-8-yl acetate, 3a,4,5,6,7,7a-hexahydro-4,7-methanoinden-6-yl acetate, 2-tert-butylcyclohexyl acetate, cis-2-tert-butylcyclohexyl acetate, trans-2-tert-butylcyclohexyl acetate, 4-tert-butylcyclohexyl acetate, cis-4-tert-butylcyclohexyl acetate, trans-4-tert-butylcyclohexyl acetate, 3a,4,5,6,7,7a-hexahydro-4,7-methano-1H-indenyl propionate, 3a,4,5,6,7,7a-hexahydro-4,7-methano-1H-inden-6-yl propionate, 3a,4,5,6,7,7a-hexahydro-4,7-methano-1H-inden-5-yl propionate, benzyl salicylate, cyclohexyl salicylate, pentyl salicylate, 2-methylbutyl salicylate, isopentyl salicylate, exo-1,7,7-trimethylbicyclo[2.2.1]hept-2-yl acetate, p-menth-1-en-8-yl acetate, terpineol acetate, benzyl acetate, hexyl salicylate, α,α-dimethylphenethyl acetate, 1-phenylethyl acetate, linalyl acetate, phenethyl acetate, hexyl acetate, citronellyl acetate, geranyl acetate, neryl acetate, citronellyl acetate, p-menthan-8-yl acetate, α,α-4-trimethylcyclohexylmethyl acetate, nopyl acetate, ethyl acetoacetate, 3-methyl-2-butenyl acetate, 2-cyclohexylethyl acetate, [3R-(3α,3aβ,7β,8aα)]-2,3,4,7,8,8a-hexahydro-3,8,8-trimethyl-1H-3 a,7-methano-azulene-6-methyl acetate, phenethylphenyl acetate, (Z)-3-hexenyl salicylate, isononyl acetate, isobutyl salicylate, (Z)-hex-3-enyl acetate, 1,3-dimethyl-3-phenylbutyl acetate, methyl salicylate, isopentyl acetate, neryl acetate, cinnamyl acetate, menthyl acetate, 1,2,3,3a,4,5,6,8a-octahydro-2-isopropylidene-4,8-dimethylazulen-6-yl acetate, allylphenoxy acetate, decahydro-2-naphthyl acetate, myrcenyl acetate, methylphenyl acetate, ethyl salicylate, 3(or 4)-(4-methylpenten-3-yl)cyclohex-3-ene-1-methyl acetate, 1-methyl-1-((3S,8S)-1,2,3,4,5,6,7,8-octahydro-3,8-dimethylazulen-5-yl)ethyl acetate, ethyl acetate, phenyl salicylate, phenethyl salicylate, p-tolyl acetate, p-tolylphenyl acetate and/or 1,1,5-trimethylhepta-4,6-dienyl acetate. Among these, especially hexyl acetate, phenethyl acetate and/or 1-phenylethyl acetate are to be stressed.

Individual or pluralities of other perfume compounds such as synthetic products of the ester, ether, aldehyde, ketone, alcohol and hydrocarbon type can be used as additional perfumes together with the perfume esters. Preferred ethers include benzyl ethyl ether. Aldehydes include linear alkanals containing 8 to 18 carbon atoms, citral, citronellal, citronellyloxyacetaldehyde, cyclamen aldehyde, hydroxycitronellal, lilial and bourgeonal. Ketones include ionones, α-isomethyl ionone and methyl cedryl ketone. Alcohols include anethol, citronellol, eugenol, geraniol, linalool, phenylethyl alcohol and terpineol. Hydrocarbons include, above all, the terpenes and balsams.

If mixtures of different perfumes are used in combination with perfume ester(s), then it is particularly preferred that an attractive and individually customizable fragrant note be produced. In the context of the present invention, these mixtures of individual substances are considered to be perfumes or perfume oils or perfume compositions, wherein the inventive effect of the enhancement of the fragrance anchoring of the perfume ester on the treated surface, especially in regard to dried objects, has a positive impact on the fragrance impression of the perfume composition as a whole. The perfume oil can also contain natural mixtures of odoriferous substances from vegetal or animal sources, for example, pine, citrus, jasmine, lilac, rose or ylang-ylang oil. Ethereal oils of lower volatility that are mostly used as aroma components are also suitable perfume oils (e.g., oil of sage, chamomile oil, clove oil, melissa oil, mint oil, cinnamon leaf oil, lime blossom oil, juniper berry oil, vetivert oil, olibanum oil, galbanum oil, labolanum oil and lavender oil). Preferably, bergamot oil, dihydromyrcenol, lilial, lyral, citronellol, phenylethyl alcohol, α-hexylcinnamaldehyde, geraniol, benzyl acetone, cyclamen aldehyde, linalool, boisambrene forte, ambroxane, indole, hedione, sandelice, lemon oil, mandarin oil, orange oil, allyl amyl glycolate, cyclovertal, lavender oil, muscatel oil of sage, β-damascone, geranium oil, bourbon, cyclohexyl salicylate, Vertofix coeur, iso-E-super, Fixolide NP, Evernyl, Iraldein gamma, phenylacetic acid, geranyl acetate, benzyl acetate, rose oxide, Romillat, Irotyl and Floramate can be comprised in an inventive perfume mixture that includes perfume ester.

Enzymes (hydrolases, such as especially mannanase, protease and/or amylase) used according to the invention can also be absorbed on carrier materials and/or embedded in encapsulants. This corresponds to a preferred embodiment of the invention. This allows them to be protected even better when needed against a premature inactivation.

Preferably, proteases (preferably subtilases, especially subtilisins) can be added in order to anchor perfume esters onto hard and/or soft surfaces. A useful agent preferably comprises Savinase® and/or an optionally genetically modified protease of Bacillus lentus. Proteases of the subtilisin type are most preferred.

It is known to add proteases as protein-cleaving enzymes in washing and cleaning agents for removing corresponding protein-containing stains. In contrast, use of proteases (preferably subtilases, especially subtilisins) in washing or cleaning agents or cosmetics for the purpose of improving the fragrance impression of perfume esters according to the present invention was previously unknown.

In addition to proteases obtained from various Bacillus species or genetically modified proteases such as Alcalase®, Esperase®, Savinase®, Durazym® or Everlase®, useful proteases include those from Bacillus lentus (BLAP) that are stable and active under alkaline conditions. These can be produced in Bacillus lentus (DSM 5483) as described in international patent application WO 91/02792, or also by fermentation of Bacillus licheniformis that has been transformed with an expression plasmid carrying the gene for BLAP under the control of the promoter from Bacillus licheniformis ATCC 53926. The composition as well as the spatial structure of BLAP is known (D. W. Godette et al., J. Mol. Biol. Vol. 228, pp. 580-595 (1992)). This protease is characterized by the sequence of 269 amino acids described in the cited reference, a calculated molecular weight of 26,823 Dalton and a theoretical isoelectric point of 9.3. Variants obtained by mutation of this Bacillus lentus DSM 5483 protease are described in U.S. Pat. No. 5,340,735. Among these, protease enzymes are preferred that cause a particularly low material damage or decomposition of the fiber strands of textiles made of proteinogenic fibers, for example, fabrics of natural silk or wool, without loss of cleaning power, particularly for repeated washings.

Particularly useable proteases include, beside naturally occurring proteases from Bacillus lentus, also genetically modified proteases of the abovementioned BLAP type, in which the amino acid leucin (L in the conventional one letter code) present in the wild type protease in position 211 (BLAP numerotation), is exchanged for aspartic acid (D) or glutamic acid (E) (L211 D or L211 E). They can be manufactured as described in International Patent Application Publication No. WO 95/23221.

Additionally, further modifications to the original Bacillus lentus protease can be undertaken such as at least one of the amino acid exchanges S3T, V4I, R99G, R99A, R99S, Al 88P, V193M and/or V199I. Use of a variant is particularly preferred wherein at least one of the amino acid exchanges S3T, V4I, A188P, V193M, V199I and/or L211 D was undertaken. In the protease nomenclature described above for the exchange of individual amino acids, it should be noted that numeration of the amino acid positions in the numbering of the alkaline proteases from Bacillus lentus (BLAP) differs from numbering of the subtilisin BPN′.

It should be made clear here that with the term “useful agent”, reference is made to the inventive process and inventive use described further below, in the sense that the inventively employable or useful agent (e.g., a washing agent comprising perfume ester and hydrolase such as mannanase) is used in the inventive process, for example, the agent in question is used to prepare the aqueous treatment liquor required for the process.

Preferably, starch-degrading enzymes, especially amylases, can be inventively added in order to anchor perfume esters on hard and/or soft surfaces. Amylases normally play the role of facilitating the removal of starch-containing soils by the catalytic hydrolysis of the starch polysaccharide. In the scope of the invention, one can preferably use amylases of the α-type from Bacillus licheniformis (sold, for example, by Novozymes Co. under the trade name Termamyl®), as well as genetically modified amylases (i.e., those with genetically changed amino acid sequences with respect to the naturally occurring amylases such as those known from international patent applications WO 94/18314 or WO 95/21247). Examples of further useable amylases according to the invention include the α-amylase from Bacillus licheniformis, the α-amylases from B. amyloliquefaciens, from B. stearothermophilus, from Aspergillus niger and A. oryzae, as well as their improved further developments for use in laundry detergents and cleaning agents. Moreover, for these purposes, attention should be drawn to the α-amylase from Bacillus sp. A 7-7 (DSM 12368) and the cyclodextrin-glucanotransferase (CGTase) from B. agaradherens (DSM 9948). Use of amylases in washing or cleaning agents or cosmetics for improving the fragrance impression of perfume esters, as has been surprisingly discovered by us, appears to be previously unknown.

In addition, enzymes which are summarized by the term hemicellulases can be inventively added. These include mannanases, xanthanlyases, pectinlyases (=pectinases), pectinesterases, pectatlyases, xyloglucanases (=xylanases), pullulanases and β-glucanases. In this regard, suitable enzymes are available under the names Gamanase® and Pektinex AR® from the Novozymes Company, under the names Rohapec® B1 L from AB Enzymes and under the names Pyrolase® from Diversa Corp., San Diego, Calif., USA. β-Glucanase, extracted from B. Subtilis, is available under the name Cereflo® from the Novozymes Company. Hemicellulases that are particularly preferred include mannanases (e.g., those marketed for example under the tradenames Mannaway® from the Novozymes Company or Purabrite® from the Genencor Company). Mannanase can be employed in washing or cleaning agents normally to remove mannan-containing residues in textile washing. Use of mannanases in washing or cleaning agents or cosmetics for the purpose of improving the fragrance impression of perfume esters as has been surprisingly discovered by us, appears to be previously unknown.

According to a preferred embodiment of the process according to the invention, the treatment time of the surface with the aqueous treatment liquor is the range of about 2 to about 120 minutes, especially from about 10 minutes to about 80 minutes. If the temperature of the aqueous treatment liquor is in the range of about 15° C. to about 90° C., especially from about 20° C. to about 60° C., then this is also a preferred embodiment of the process according to the invention. In this regard it is particularly advantageous if the temperature of the aqueous treatment liquor is in the range of about 20° C. to about 60° C. during the length of treatment time. By doing so, particularly good fragrance results are achieved, especially for dry objects. It should be understood that the term “dry object” refers to surfaces such as textiles that were first subjected to a process according to the invention and consequently came into contact with an inventive aqueous treatment liquor (L e., were wet and afterwards were left to dry, for example in ambient air, or were subjected to a drying step, for example in a tumble drier).

According to a preferred embodiment of the process according to the invention, the concentration of the inventively employable hydrolase in the aqueous treatment liquor is in the range of about 0.0001 mg/l to about 0.25 g/l, especially from about 0.01 mg/l to about 15 mg/l. According to a preferred embodiment of the process according to the invention, the concentration of the inventively employable perfume ester in the aqueous treatment liquor is in the range of about 0.0001 g/l to about 0.25 g/l, especially from about 0.001 g/l to about 0.05 g/l. A likewise preferred embodiment of the process according to the invention is when the treatment liquor contains anionic and/or non-ionic surfactant. Surprisingly, the effect of the inventive fixing of perfume esters could be confirmed, particularly also in the presence of greater amounts of anionic and/or non-ionic surfactant in an inventively employable agent (e.g., in amounts > about 5 wt. %, > about 10 wt. % or even > about 15 wt. %, based on the total agent).

Another subject matter of the invention concerns a method for fixing perfume esters on hard and/or soft surfaces when washing or cleaning the hard and/or soft surfaces with perfume ester-containing treatment agents with the use of hydrolases (preferably selected from a) glycosidases, preferably a1) hemicellulases, particularly preferably mannanase and/or, a2) starch-degrading enzymes, particularly preferably amylase and/or, b) proteases, preferably subtilases, especially subtilisins). The fixing, meaning an improved adhesion, yields, as described above, a prolonged/enhanced fragrance effect of the perfume ester on the treated surface, especially on the dry object, while promoting the fragrance effect of other perfumes if a perfume ester-containing perfume composition is used, again especially on the dry object, which can be confirmed by odor assessment of the treated object, preferably by perfumers, especially 7 days after drying. The just mentioned inventive method for fixing perfume esters on surfaces is particularly advantageous, especially when washing textiles, preferably in an automatic washing machine. Another advantage is that this inventive fixing then also even involves a prolonged/enhanced fragrance effect of the perfume ester on the treated surface if the laundered textile washing is subsequently subjected to a textile drying step in an automatic textile dryer, in particular in a vented or condensing dryer. This is a particular advantage because it is often the case that the fragrance of the textile to be dried is lost to a very considerable degree in the drying step in an automatic textile dryer.

A preferred embodiment of the invention concerns the inventive use of the hydrolase (preferably selected from a) glycosidases, preferably a1) hemicellulases, particularly preferably mannanase and/or, a2) starch-degrading enzymes, particularly preferably amylase and/or, b) proteases, preferably subtilases, especially subtilisins) employed in parts by weight, based on the perfume ester, in the range 1:0.05 to 1:20.

Another subject matter of the present invention concerns a method for prolonging/enhancing the fragrance effect of the perfume ester in perfume ester-containing liquid or solid washing or cleaning agents, after the washing or cleaning application on a hard and/or soft surface to be treated, especially relating to the dry object, with the use of hydrolases (preferably selected from a) glycosidases, preferably a1) hemicellulases, particularly preferably mannanase and/or, a2) starch-degrading enzymes, particularly preferably amylase and/or, b) proteases, preferably subtilases, especially subtilisins). The described prolonging/enhancing of the fragrance effect of the perfume ester is the result of its improved fixing onto the treated surface. The volatility of the perfume ester is slowed down by the improved fixing. Improved fixing does not mean that the deposition of the perfume ester onto the surfaces is improved, rather that the deposited perfume adheres better.

It is particularly preferred if the washing or cleaning agent in question comprises the hydrolase (preferably selected from a) glycosidases, preferably a1) hemicellulases, particularly preferably mannanase and/or, a2) starch-degrading enzymes, particularly preferably amylase and/or, b) proteases, preferably subtilases, especially subtilisins) in amounts of about 0.0000001 to about 5 wt. %, preferably about 0.000001 to about 4 wt. %, advantageously about 0.00001 to about 3 wt. %, more advantageously about 0.0001 to about 2 wt. %, further advantageously 0.001 to about 1 wt. %, even more advantageously 0.01 to about 0.5 wt. %, particularly about 0.05 to about 0.1 wt. %, wt. % based on the total agent. The cited upper and lower limits can be varied, such that the hydrolase can be comprised in the washing or cleaning agent in question in amounts of about 0.00001 to about 0.1 wt. %, e.g. in amounts of about 0.00001 to about 0.072 wt. % based on total agent.

Perfume esters employed in the process according to the invention include 3a,4,5,6,7,7a-hexahydro-4,7-methano-1H-indenyl acetate, tricyclo-[5.2.1.02,6]dec-4-en-8-yl acetate, 3a,4,5,6,7,7a-hexahydro-4,7-methanoinden-6-yl acetate, 2-tert-butylcyclohexyl acetate, cis-2-tert-butylcyclohexyl acetate, trans-2-tert-butylcyclohexyl acetate, 4-tert-butylcyclohexyl acetate, cis-4-tert-butylcyclohexyl acetate, trans-4-tert-butylcyclohexyl acetate, 3a,4,5,6,7,7a-hexahydro-4,7-methano-1H-indenyl propionate, 3a,4,5,6,7,7a-hexahydro-4,7-methano-1H-inden-6-yl propionate, 3a,4,5,6,7,7a-hexahydro-4,7-methano-1H-inden-5-yl propionate, benzyl salicylate, cyclohexyl salicylate, pentyl salicylate, 2-methylbutyl salicylate, isopentyl salicylate, exo-1,7,7-trimethylbicyclo[2.2.1]hept-2-yl acetate, p-menth-1-en-8-yl acetate, terpineol acetate, benzyl acetate, hexyl salicylate, alpha, alpha.-dimethylphenethyl acetate, 1-phenylethyl acetate, linalyl acetate, phenethyl acetate, hexyl acetate, citronellyl acetate, geranyl acetate, neryl acetate, citronellyl acetate, p-menthan-8-yl acetate, alpha,alpha-4-trimethylcyclohexylmethyl acetate, nopyl acetate, ethyl acetoacetate, 3-methyl-2-butenyl acetate, 2-cyclohexylethyl acetate, [3R-(3.alpha.,3a.beta.,7.beta.,8a.alpha.)]-2,3,4,7,8,8a-hexahydro-3,8,8-trimethyl-1H-3a7-methano-azulene-6-methyl acetate, phenethylphenyl acetate, (Z)-3-hexenyl salicylate, isononyl acetate, isobutyl salicylate, (Z)-hex-3-enyl acetate, 1,3-dimethyl-3-phenylbutyl acetate, methyl salicylate, isopentyl acetate, neryl acetate, cinnamyl acetate, menthyl acetate, 1,2,3,3a,4,5,6,8a-octahydro-2-isopropylidene-4,8-dimethylazulen-6-yl acetate, allylphenoxy acetate, decahydro-2-naphthyl acetate, myrcenyl acetate, methylphenyl acetate, ethyl salicylate, 3(or 4)-(4-methylpenten-3-yl)cyclohex-3-ene-1-methyl acetate, 1-methyl-1-((3S,8S)-1,2,3,4,5,6,7,8-octahydro-3,8-dimethylazulen-5-yl)ethyl acetate, ethyl acetate, phenyl salicylate, phenethyl salicylate, p-tolyl acetate, p-tolylphenyl acetate and/or 1,1,5-trimethylhepta-4,6-dienyl acetate, especially hexyl acetate, phenethyl acetate and/or 1-phenylethyl acetate.

As already clarified, the process according to the invention can be carried out with a typical agent that includes the perfume ester and the hydrolase. The same is true for the method according to the invention. Such a typical agent that comprises the perfume ester and hydrolase can be in particular a textile washing agent or textile-care product, which can be in particulate or liquid form, a cleaning agent in a suitable form for hard surfaces, for example a tile cleaner, a bath cleaner or sanitary cleaner, or a cleaning agent for the human body, for example a hair shampoo, a cleaning lotion, a shower gel or a piece of soap. In particular, the inventive teaching can also be employed in the field of personal hygiene.

In addition, inventively employable agents include powdered solids, in post-compressed particulate form, in molded form (especially tablet form) as homogeneous solutions or suspensions, and can contain all the usual ingredients that are suitable for the use of the corresponding agents.

Inventively employable washing or cleaning agents can comprise builders, surface active surfactants, optional additional enzymes, organic and/or inorganic peroxygen compounds, peroxygen activators, water-miscible organic solvents, sequestrants, electrolytes, pH adjusters, thickeners and additional auxiliaries, such as soil release active substances, optical brighteners, graying inhibitors, color transfer inhibitors, foam regulators as well as colorants.

The inventively employable agents, particularly washing or cleaning agents, can preferably comprise surfactants such as anionic surfactants, non-ionic surfactants and their mixtures, but also cationic surfactants. Suitable non-ionic surfactants include ethoxylation and/or propoxylation products of alkyl glycosides and/or linear or branched alcohols, each with 12 to 18 carbon atoms in the alkyl moiety and 3 to 20, preferably 4 to 10 alkyl ether groups. Moreover, corresponding ethoxylation and/or propoxylation products of N-alkylamines, vicinal diols, fatty acid esters and fatty acid amides, which in regard to the alkyl moiety correspond to the cited long chain alcohol derivatives, as well as alkyl phenols with 5 to 12 carbon atoms in the alkyl group can be used.

Suitable anionic surfactants include soaps and such that comprise sulfate or sulfonate groups, preferably with alkali metal ions as the cations. Useful soaps include alkali metal salts of saturated or unsaturated fatty acids with 12 to 18 carbon atoms. These types of fatty acids can also be used in a not completely neutralized form. Useful sulfate surfactants include the salts of sulfuric acid half esters of fatty alcohols with 12 to 18 carbon atoms and the sulfation products of the mentioned non-ionic surfactants with a low degree of ethoxylation. Useful sulfonate surfactants include linear alkylbenzene sulfonates with 9 to 14 carbon atoms in the alkyl moiety, alkyl sulfonates with 12 to 18 carbon atoms, as well as olefin sulfonates with 12 to 18 carbon atoms, which result from the reaction of corresponding monoolefins with sulfur trioxide, as well as α-sulfofatty acid esters that result from the sulfonation of fatty acid methyl or ethyl esters.

Cationic surfactants are preferably selected from the esterquats and/or the quaternary ammonium compounds (QUATS) according to the general formula (R^{I})(R^{II})(R^{III})(R^{IV})N⁺X⁻, in which R^{I} to R^{IV} may be the same or different C₁₋₂₂ alkyl groups, C₇₋₂₈ arylalkyl groups or heterocyclic groups, wherein two or, in the case of an aromatic bonding such as in pyridine, even three groups together with the nitrogen atom form the heterocycle, for example, a pyridinium or imidazolinium compound, and X⁻ represents halide ions, sulfate ions, hydroxide ions or similar anions. QUATS can be obtained by reacting tertiary amines with alkylating agents such as methyl chloride, benzyl chloride, dimethyl sulfate, dodecyl bromide, as well as ethylene oxide. The alkylation of tertiary amines having one long alkyl chain and two methyl groups is particularly easy. The quaternization of tertiary amines containing two long chains and one methyl group can also be carried out under mild conditions using methyl chloride. Amines containing three long alkyl chains or hydroxy-substituted alkyl chains lack reactivity and are quaternized with dimethyl sulfate, for example. Suitable QUATS include benzalkonium chloride (N-alkyl-N,N-dimethylbenzylammonium chloride, Benzalkon B (m,p-dichlorobenzyl dimethyl-C₁₂-alkylammonium chloride, Benzoxonium chloride (benzyldodecyl-bis-(2-hydroxyethyl)ammonium chloride), Cetrimonium bromide (N-hexadecyl-N,N-trimethyl ammonium bromide, Benzetonium chloride (N,N-di-methyl-N-[2-[2-[p-(1,1,3,3-tetramethylbutyl)-phenoxy]ethoxy]-ethyl]-benzylammonium chloride, dialkyldimethylammonium chlorides, such as di-n-decyldimethylammonium chloride, didecyldimethylammonium bromide, dioctyldimethylammonium chloride, 1-cetylpyridinium chloride and thiazoline iodide and mixtures thereof. Preferred QUATS are the benzalkonium chlorides containing C₈-C₂₂ alkyl groups, more particularly C₁₂₋₁₄ alkylbenzyldimethylammonium chloride.

Ester quats include compounds of the general Formula I

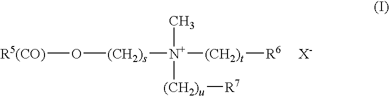

wherein R⁵ is an alkyl or alkenyl group with 12 to 22 carbon atoms and 0, 1, 2 or 3 double bonds; R⁶ and R⁷ are each independently H, OH or O(CO)R⁵; s, t and u are each independently 1, 2 or 3; and X⁻ is an anion, particularly halide, methosulfate, methophosphate or phosphate as well as mixtures thereof. Preferred compounds comprise a group O(CO)R⁵ for R⁶ and an alkyl group with 16 to 18 carbon atoms for R⁵. Particularly preferred are compounds in which R⁷ stands for OH. Examples of compounds according to Formula (V) include methyl-N-(2-hydroxyethyl)-N,N-di(tallowacyloxyethyl)ammonium methosulfate, bis(palmitoyl)ethylhydroxyethylmethylammonium methosulfate or methyl-N,N-bis(acyloxyethyl)-N-(2-hydroxyethyl)ammonium methosulfate. When quaternized compounds of Formula (V) are used that have unsaturated groups, the acyl groups are preferred, whose corresponding fatty acids have an iodine number between 5 and 80, preferably between 10 and 60 and particularly between 15 and 45 and/or which have a cis/trans isomer ratio (in mol %) of greater than 30:70, preferably greater than 50:50 and in particular greater than 70:30. Commercial examples are the methylhydroxyalkyldialcoyloxyalkylammonium methosulfates marketed by the Stepan company under the trade name Stepantex® or known products from Cognis Deutschland GmbH with the trade name Dehyquart® or the known products manufactured by Goldschmidt-Witco under the name Rewoquat®.

Surfactants can be included in the inventively employable agents, in particular in washing or cleaning agents, in amounts of about 5 wt. % to about 50 wt. %, especially from about 8 wt. % to 3 about 0 wt. %. Preferably up to about 30 wt. %, especially about 5 wt. % to about 15 wt. % of surfactants, among which at least a part is preferably cationic surfactants, are present in inventively employable laundry conditioners.

An inventively employable agent preferably comprises at least one water-soluble and/or water-insoluble organic and/or inorganic builder. Water-insoluble organic builders include polycarboxylic acids, particularly citric acid and sugar acids, monomeric and polymeric amino polycarboxylic acids, particularly methyl glycine diacetic acid, nitrilotriacetic acid and ethylenediamine tetraacetic acid as well as polyaspartic acid, polyphosphonic acids, particularly amino tris(methylene phosphonic acid), ethylenediaminetetrakis(methylene phosphonic acid) and 1-hydroxyethane-1,1-diphosphonic acid, polymeric hydroxyl compounds such as dextrin as well as polymeric (poly)carboxylic acids, particularly those polycarboxylates obtained from the oxidation of polysaccharides polymeric acrylic acids, methacrylic acids, maleic acids and mixed polymers thereof, which can also comprise small amounts of copolymerizable substances exempt from carboxylic acid functionality

The relative molecular weight of homopolymers of unsaturated carboxylic acids is generally from about 5000 to about 200,000 m, and for copolymers is from about 2000 to about 200,000, preferably from about 50,000 to about 120,000, each based on the free acid. A particularly preferred acrylic acid-maleic acid copolymer has a relative molecular weight of about 50,000 to about 100,000.

Suitable, yet less preferred compounds of this class include copolymers of acrylic acid or methacrylic acid with vinyl ethers, such as vinyl methyl ethers, vinyl esters, ethylene, propylene and styrene, in which the content of the acid is at least 50 wt. %.

Terpolymers, which comprise two unsaturated acids and/or their salts as monomers as well as vinyl alcohol and/or a vinyl alcohol derivative or a carbohydrate as the third monomer, can also be used as the water-soluble organic builders. The first acid monomer or its salt is derived from a monoethylenically unsaturated C₃-C₈ carboxylic acid and preferably from a C₃-C₄ monocarboxylic acid, particularly from (meth)acrylic acid. The second acid monomer or its salt can be a derivative of a C₄-C₈ dicarboxylic acid, maleic acid being particularly preferred. In this case the third monomer unit is formed from vinyl alcohol and/or preferably an esterified vinyl alcohol. In particular, vinyl alcohol derivatives are preferred which represent an ester of short chain carboxylic acids, for example C₁-C₄ carboxylic acids, with vinyl alcohol. Preferred polymers comprise from about 60 wt. % to about 95 wt. %, particularly about 70 wt. % to about 90 wt. % (meth)acrylic acid or (meth)acrylate, particularly preferably acrylic acid or acrylate, and maleic acid or maleate as well as about 5 wt. % to about 40 wt. %, preferably about 10 wt. % to about 30 wt. % vinyl alcohol and/or vinyl acetate. Polymers are quite particularly preferred, in which the weight ratio (meth)acrylic acid or (meth)acrylate to maleic acid or maleate is from about 1:1 to about 4:1, preferably from about 2:1 to about 3:1 and particularly about 2:1 to about 2.5:1. Here, both the quantities and the weight ratios are based on the acids. The second acid monomer or its salt can also be a derivative of an allyl sulfonic acid, which is substituted in the 2-position with an alkyl group, preferably a C₁-C₄ alkyl group, or an aromatic group that is preferably derived from benzene or benzene derivatives. Preferred terpolymers comprise about 40 wt. % to about 60 wt. %, particularly about 45 wt. % to about 55 wt. % (meth)acrylic acid or (meth)acrylate, particularly preferably acrylic acid or acrylate, about 10 wt. % to about 30 wt. %, preferably about 15 wt. % to about 25 wt. % methallyl sulfonic acid or methallyl sulfonate and as the third monomer about 15 wt. % to about 40 wt. %, preferably about 20 wt. % to about 40 wt. % of a carbohydrate. This carbohydrate can, for example, be a mono, di, oligo or polysaccharide, mono, di or oligosaccharides being preferred. Saccharose is particularly preferred. Adding the third monomer presumably creates intended weak points in the polymer, which are responsible for the good biological degradation of the polymer. In general, terpolymers possess a relative molecular weight from about 1000 to about 200,000, preferably from about 200 to about 50,000 and particularly from about 3000 to about 10,000. Other preferred copolymers are those which preferably contain acrolein and acrylic acid/acrylic acid salts or vinyl acetate as monomers.

Organic builders, especially for the manufacture of liquid agents, can be added in the form of aqueous solutions, preferably in the form of about 30 to about 40 weight percent aqueous solutions. In general, all cited acids are added in the form of their water-soluble salts, particularly their alkali metal salts. These types of organic builders can be comprised as desired in amounts of up to about 40 wt. %, particularly up to about 25 wt. % and preferably from about 1 wt. % to about 8 wt. % in the inventively employable agents. Amounts close to the cited upper limit are preferably added in pasty or liquid, particularly aqueous, inventively employable agents. Inventively employable laundry conditioners can optionally also be exempt of organic builders.

Alkali metal silicates and polyphosphates, preferably sodium triphosphate are especially used as the water-soluble builders for the inventively employable agents. In particular, crystalline or amorphous alkali metal aluminosilicates in amounts of up to about 50 wt. %, preferably not more than about 40 wt. % and in liquid agents not more than about 1 wt. % to about 5 wt. % are added as the water-insoluble, water-dispersible inorganic builders. Among these, the detergent-quality crystalline sodium aluminosilicates, particularly zeolites A, P and optionally X, are preferred. Amounts close to the cited upper limit are preferably incorporated in solid, particulate agents. Suitable aluminosilicates particularly exhibit no particles with a particle size above about 30 μm and preferably include at least about 80 wt. % of particles smaller than 10 μm. Their calcium binding capacity, determined according to the usual methods, generally lies in the range of about 100 to about 200 mg CaO per gram.

Suitable substitutes or partial substitutes for the cited alumosilicate are crystalline alkali metal silicates that can be alone or present in a mixture with amorphous silicates. The alkali metal silicates useful as builders in the inventively employable agents preferably have a molar ratio of alkali metal oxide to SiO₂ below about 0.95, particularly about 1:1.1 to about 1:12 and can be amorphous or crystalline. Preferred alkali metal silicates include sodium silicates, particularly amorphous sodium silicates, with a molar ratio Na₂O:SiO₂ of about 1:2 to about 1:2.8. Crystalline silicates that can be present alone or in a mixture with amorphous silicates are preferably crystalline, layered silicates corresponding to the general formula Na₂SiₓO₂ₓ₊₁yH₂O, wherein x, the so-called module, is a number from 1.9 to 4 and y is a number from 0 to 20, preferred values for x being 2, 3 or 4. Preferred crystalline layered silicates are those in which x assumes the values 2 or 3 in the cited general formula. In particular, both β- and δ-sodium disilicates (Na₂Si₂O₅yH₂O) are preferred. Practically anhydrous crystalline alkali metal silicates of the abovementioned general formula in which x is a number from 1.9 to 2.1 can also be manufactured from amorphous alkali metal silicates, and can be used in inventively employable agents. In a further preferred embodiment of the inventively employable agent, a crystalline sodium layered silicate with a module of 2 to 3 is added, as can be manufactured from sand and soda. In a further preferred embodiment of the inventive agent, crystalline sodium silicates with a module in the range 1.9 to 3.5 can be added. When alkali metal aluminosilicate, in particular zeolite, is also present as the additional builder, then the weight ratio aluminosilicate to silicate, each based on the anhydrous active substances, is preferably 1:10 to 10:1. In agents containing both amorphous and crystalline alkali metal silicates, the weight ratio of amorphous alkali metal silicate to crystalline alkali metal silicate is preferably 1:2 to 2:1 and particularly 1:1 to 2:1.

Builders can be present in the inventively employable agents, in particular washing agents, preferably in amounts of up to about 60 wt. %, especially from about 5 wt. % to about 40 wt. %. Inventively employable laundry conditioners are preferably exempt from inorganic builders.

Suitable peroxygen compounds that may be used in the inventively employable agents particularly include organic peracids or peracid salts of organic acids such as phthalimide percaproic acid, perbenzoic acid or salts of diperoxydodecanedioic acid, hydrogen peroxide and inorganic salts that liberate hydrogen peroxide under the application conditions, such as perborate, percarbonate and/or persilicate. If solid peroxygen compounds are used, then they can be used in the form of powders or pellets, which can also be encapsulated by known methods. Alkali percarbonate, alkali perborate monohydrate or particularly in liquid agents hydrogen peroxide in the form of aqueous solutions that comprise about 3 wt. % to about 10 wt. % hydrogen peroxide are particularly preferably used. When an inventive washing agent comprises peroxygen compounds then the latter are present in amounts of preferably up to about 50 wt. %, especially about 5 wt. % to about 30 wt. %. The addition of minor quantities of known bleaching agent activators such as phosphonates, borates or metaborates and metasilicates, as well as magnesium salts such as magnesium, can be useful.

Useful bleach activators include compounds which, under perhydrolysis conditions, yield aliphatic peroxycarboxylic acids having preferably 1 to 10 carbon atoms, in particular 2 to 4 carbon atoms, and/or optionally substituted perbenzoic acid. Substances, which carry O-acyl and/or N-acyl groups of said number of carbon atoms and/or optionally substituted benzoyl groups, are suitable. Polyacylated alkylenediamines are preferred, especially tetraacetylethylenediamine (TAED), as well as acylated phenol sulfonates, in particular n-nonanoyl- or isononanoyloxybenzene sulfonate (n- or iso-NOBS). Combinations of conventional bleach activators may also be used. These types of bleach activators can be included in usual quantity range of about 1 to about 10 wt. %, particularly about 2 wt. % to about 8 wt. %, based on total employable agent.

In addition to or instead of the above-listed conventional bleach activators, inventively employable agents can also include sulfonimines and/or bleach boosting transition metal salts or transition metal complexes as so-called bleach catalysts. The possible transition metal compounds include, in particular, salen complexes of manganese, iron, cobalt, ruthenium or molybdenum and their analogous N-compounds, the carbonyl complexes of manganese, iron, cobalt, ruthenium or molybdenum, the nitrogen-containing tripod ligand complexes of manganese, iron, cobalt, ruthenium, molybdenum, titanium, vanadium and copper, and the ammine complexes of cobalt, iron, copper and ruthenium. Combinations of bleach activators and transition metal bleach catalysts can likewise be employed. Bleach boosting transition metal complexes, in particular with the central atoms Mn, Fe, Co, Cu, Mo, V, Ti and/or Ru, can be added in usual amounts, preferably in an amount of up to 1 wt. %, particularly from 0.0025 wt. % to 0.25 wt. % and particularly preferably from 0.01 to 0.1 wt. %, each based on the total agent.

Additionally employable enzymes in the inventively employable agents can include those from the classes of the cutinases, pullulanases, hemicellulases, cellulases, lipases, oxidases and peroxidases as well as mixtures thereof. Enzymatic active materials obtained from bacterial sources or fungi such as Bacillus subtilis, Bacillus licheniformis, Streptomyceus griseus, Humicola lanuginosa, Humicola insolens, Pseudomonas pseudoalcaligenes or Pseudomonas cepacia are particularly suitable. These optionally employable enzymes can be adsorbed on carriers and/or embedded in encapsulants in order to protect them against premature inactivation.

Inventively employable agents can comprise derivatives of diaminostilbene disulfonic acid or alkali metal salts thereof as optical brighteners. Salts of 4,4′-bis(2-anilino-4-morpholino-1,3,5-triazinyl-6-amino)stilbene-2,2′-disulfonic acid, etc., are also suitable.

Suitable foam inhibitors include organopolysiloxanes and mixtures thereof with microfine, optionally silanized silica and also paraffin waxes and mixtures thereof with silanized silica or bis-fatty acid ethylenediamides. Mixtures of different foam inhibitors, for example mixtures of silicones, paraffins or waxes, are also used with advantage. Preferably, the foam inhibitors, especially silicone-containing and/or paraffin-containing foam inhibitors, are loaded onto a granular, water-soluble or dispersible carrier material. Especially in this case, mixtures of paraffins and bis-stearylethylenediamides are preferred.

In addition, the inventively employable agents can also comprise components that positively influence oil and fat removal from textiles during the wash, so-called soil release active substances. This effect is particularly noticeable when a textile is soiled and had been previously already washed several times with a washing agent that comprised this oil- or fat-removing component. The preferred oil and fat removing components include, for example, non-ionic cellulose ethers such as methyl cellulose and methyl hydroxypropyl cellulose with a content of methoxy groups of about 15 to about 30 wt. % and hydroxypropoxy groups of about 1 to about 15 wt. %, each based on the non-ionic cellulose ether, as well as polymers of phthalic acid and/or terephthalic acid or their derivatives with monomeric and/or polymeric diols known from the prior art, particularly polymers of ethylene terephthalates and/or polyethylene glycol terephthalates or anionically and/or non-ionically modified derivatives thereof.

The inventively employable agents can also comprise color transfer inhibitors, preferably in amounts of about 0.1 wt. % to about 2 wt. %, especially about 0.1 to about 1 wt. % which in a preferred development of the invention are polymers of vinyl pyrrolidone, vinylimidazole, vinylpyridine N-oxide or copolymers of these. Both polyvinyl pyrrolidones with molecular weights of about 15,000 to about 50,000, as well as polyvinyl pyrrolidones with molecular weights over about 1,000,000, in particular from about 1,500,000 to about 4,000,000, N-vinylimidazole/N-vinyl pyrrolidone copolymers, polyvinyloxazolidones, copolymers based on vinyl monomers and carboxylic acid amides, pyrrolidone group-containing polyesters and polyamides, grafted polyamido amines and polyethylene imines, polymers with amide groups from secondary amines, polyamine N-oxide polymers, polyvinyl alcohols and copolymers based on acrylamido alkenyl sulfonic acids can be employed. However, enzymatic systems which include a peroxidase and hydrogen peroxide or a substance that releases hydrogen peroxide in water can also be added. The addition of a mediator compound for the peroxidase, for example, an acetosyringone, a phenol derivative or a phenothiazine or phenoxazine is preferred in this case, wherein in addition, the above-mentioned polymeric color transfer inhibitor active substances can also be used. In agents according to the invention, polyvinyl pyrrolidone with an average molecular weight of about 10,000 to about 60,000, particularly about 25,000 to about 50,000, is preferably added. Preferred copolymers are those of vinyl pyrrolidone and vinylimidazole with a molar ratio of about 5:1 to about 1:1, with an average molecular weight of about 5000 to about 50,000, particularly about 10,000 to about 20,000.

Graying inhibitors have the task of ensuring that the dirt removed from the textile fibers is held suspended in the wash liquid. Water-soluble colloids of mostly organic nature are suitable for this, for example starch, glue, gelatines, salts of ether carboxylic acids or ether sulfonic acids of starches or celluloses, or salts of acidic sulfuric acid esters of celluloses or starches. Water-soluble, acid group-containing polyamides are also suitable for this purpose. Moreover, aldehyde starches, for example, can be used instead of the abovementioned starch derivatives. Preference, however, is given to the use of cellulose ethers such as carboxymethyl cellulose (Na salt), methyl cellulose, hydroxyalkyl cellulose, and mixed ethers, such as methyl hydroxyethyl cellulose, methyl hydroxypropyl cellulose, methyl carboxymethyl cellulose and mixtures thereof, which can be added, for example, in amounts of about 0.1 to about 5 wt. %, based on the agent.

Organic solvents that can be employed in the inventive agents, particularly when the agents are in liquid or paste form, include alcohols with 1 to 4 carbon atoms, particularly methanol, ethanol, isopropanol and tert.-butanol, diols with 2 to 4 carbon atoms, particularly ethylene glycol and propylene glycol, their mixtures and the ethers derived from the cited classes of compounds. These types of water-miscible solvents can be comprised in the inventively employable agents, such as in particular washing or cleaning agents, preferably in amounts of not more than about 30 wt. %, especially from about 6 wt. % to about 20 wt. %.

To adjust a pH resulting from mixing the usual components to a desired level, the inventive agents can comprise acids that are compatible with the system and the environment, particularly citric acid, acetic acid, tartaric acid, malic acid, glycolic acid, succinic acid, glutaric acid and/or adipic acid, and also mineral acids, particularly sulfuric acid or bases, particularly ammonium hydroxide or alkali metal hydroxides. These types of pH adjustors can be comprised in the inventively employable agents at not more than about 20 wt. %, especially about 1.2 wt. % to about 17 wt. %.

The manufacture of solid inventively employable agents is not difficult and in principle can be made by known methods such as spray drying or granulation, wherein the peroxygen compound and bleach catalyst, when comprised, are optionally added later. For manufacturing inventively employable agents with an increased bulk density, particularly in the range of 650 g/l to 950 g/l, a preferred process is one with an extrusion step.

According to another preferred embodiment, the inventive teaching can be used in order to significantly decrease the perfume content in washing, cleaning and body care agents. This enables perfumed products to be offered even to those particularly sensitive consumers, who, due to specific intolerances and irritations, can only make limited use or are absolutely unable to use normally perfumed products. Hand washing agents, for example may be mentioned in this regard.

### EXAMPLES

Washing conditions -

| | |
|---|---|
| Washing machine: | Miele ® Novotronic ® W 308 |
| Wash program: | Soaking step Normal program boil-coloreds wash |
| Wash temperature: | 40° C. |
| Volume of wash liquor | 17 l |
| Water hardness: | 16° dH |
| Amount of laundry: | 3.5 kg clean laundry |
| Fabric: | Hand towel, 100% cotton |

TABLE 1
Composition of the employed washing agent (in wt. %)

| | W1 | V1 |
|---|---|---|
| Fatty alcohol ether sulfate | 5 | 5 |
| Fatty alcohol C_{12/14} 7EO | 12 | 12 |
| C₁₂₋₁₄ alkyl polyglycoside | 2 | 2 |
| Fatty acid C₁₂₋₁₈ | 5 | 5 |
| Glycerine | 5 | 5 |
| Na citrate | 1 | 1 |
| Na polyacrylate | 0.2 | 0.2 |
| Hexyl acetate | 0.1 | 0.1 |
| Mannanase | 0.01 | — |
| Water | ad 100 | ad 100 |

The hand towels were washed three times under the conditions listed above with inventive washing agent W1 that comprised 0.01 wt. % mannanase and, after the last wash, were dried in ambient air. In parallel, hand towels were treated under the same conditions with the comparative washing agent V1 (i.e., containing no mannanase). The textiles were presented to 6 trained and experienced perfumers and subjected to a comparative odor evaluation by them. The fragrance impression was assessed both for the damp washing as well as for dry washing after 7 days storage on an open shelf.

While the fragrance impression on damp washing was comparable, the addition of the inventive agent W1 on the dry washing after 7 days storage on an open shelf afforded a distinctly more intensive fragrance than with the addition of V1. This test was repeated under exactly the same conditions and gave the same result.

The washing agents X1 and Y1 were then tested against V1 under the same conditions as described above. X1 differed from V1 only in that it comprised 0.01 wt. % protease. Z1 differed from V1 only in that it comprised 0.01 wt. % amylase. The addition of the inventive agent X1 on the dry washing after 7 days storage on an open shelf afforded a distinctly more intensive fragrance than with the addition of V1. The fragrance impression on damp washing was comparable. The addition of the inventive agent Z1 on the dry washing after 7 days storage on an open shelf afforded a distinctly more intensive fragrance than with the addition of V1. The fragrance impression on damp washing was comparable.

We claim:

1. Process for fixing perfume esters to a hard or soft surface comprising:
treating a surface at a temperature of about 95° C. or less for a time of about 1 to about 300 minutes with an aqueous treatment liquor comprising one or more perfume esters and one or more hydrolases.

2. Process according to claim 1 wherein the one or more hydrolases is at least glycosidase and/or protease.

3. Process according to claim 2 wherein the one or more hydrolases is at least glycosidase and the glycosidase is at least hemicellulase and/or starch-degrading enzymes.

4. Process according to claim 3 wherein the hemicellulase is mannanase.

5. Process according to claim 3 wherein the starch-degrading enzyme is amylase.

6. Process according to claim 2 wherein the one or more hydrolases is at least protease and the protease is at least subtilases.

7. Process according to claim 6 wherein the subtilases is subtilisins.

8. Process according to claim 1 wherein the treatment time is from about 2 to about 120 minutes.

9. Process according to claim 1 wherein the temperature of the aqueous treatment liquor is from about 15° C. to about 90° C.

10. Process according to claim 1 wherein the concentration of the hydrolase in the aqueous treatment liquor is from about 0.0001 mg/l to about 0.25 g/l.

11. Process according to claim 1 wherein the concentration of perfume ester in the aqueous treatment liquor is from about 0.0001 mg/l to about 0.25 g/l.

12. Process according to claim 1 wherein the treatment liquor further comprises anionic and/or non-ionic surfactants.

13. Process according to claim 1 wherein the perfume ester is chosen from 3a,4,5,6,7,7a-hexahydro-4,7-methano-1H-indenyl acetate, tricyclo-[5.2.1.02,6]dec-4-en-8-yl acetate, 3a,4,5,6,7,7a-hexahydro-4,7-methanoinden-6-yl acetate, 2-tert-butylcyclohexyl acetate, cis-2-tert-butylcyclohexyl acetate, trans-2-tert-butylcyclohexyl acetate, 4-tert-butylcyclohexyl acetate, cis-4-tert-butylcyclohexyl acetate, trans-4-tert-butylcyclohexyl acetate, 3a,4,5,6,7,7a-hexahydro-4,7-methano-1H-indenyl propionate, 3a,4,5,6,7,7a-hexahydro-4,7-methano-1H-inden-6-yl propionate, 3a,4,5,6,7,7a-hexahydro-4,7-methano-1H-inden-5-yl propionate, benzyl salicylate, cyclohexyl salicylate, pentyl salicylate, 2-methylbutyl salicylate, isopentyl salicylate, exo-1,7,7-trimethylbicyclo[2.2.1]hept-2-yl acetate, p-menth-1-en-8-yl acetate, terpineol acetate, benzyl acetate, hexyl salicylate, alpha, alpha.-dimethylphenethyl acetate, 1-phenylethyl acetate, linalyl acetate, phenethyl acetate, hexyl acetate, citronellyl acetate, geranyl acetate, neryl acetate, citronellyl acetate, p-menthan-8-yl acetate, alpha,alpha-4-trimethylcyclohexylmethyl acetate, nopyl acetate, ethyl acetoacetate, 3-methyl-2-butenyl acetate, 2-cyclohexylethyl acetate, [3R-(3.alpha.,3a.beta.,7.beta.,8a.alpha.)]-2,3,4,7,8,8a-hexahydro-3,8,8-trimethyl-1H-3a,7-methano-azulene-6-methyl acetate, phenethylphenyl acetate, (Z)-3-hexenyl salicylate, isononyl acetate, isobutyl salicylate, (Z)-hex-3-enyl acetate, 1,3-dimethyl-3-phenylbutyl acetate, methyl salicylate, isopentyl acetate, neryl acetate, cinnamyl acetate, menthyl acetate, 1,2,3,3a,4,5,6,8a-octahydro-2-isopropylidene-4,8-dimethylazulen-6-yl acetate, allylphenoxy acetate, decahydro-2-naphthyl acetate, myrcenyl acetate, methylphenyl acetate, ethyl salicylate, 3(or 4)-(4-methylpenten-3-yl)cyclohex-3-ene-1-methyl acetate, 1-methyl-1-((3S,8S)-1,2,3,4,5,6,7,8-octahydro-3,8-dimethylazulen-5-yl)ethyl acetate, ethyl acetate, phenyl salicylate, phenethyl salicylate, p-tolyl acetate, p-tolylphenyl acetate and/or 1,1,5-trimethylhepta-4,6-dienyl acetate, but in particular comprises hexyl acetate, phenethyl acetate and/or 1-phenylethyl acetate.

14. Method of hydrolases for fixing perfume esters to hard and/or soft surfaces when washing or cleaning the hard and/or soft surfaces comprising applying a perfume ester-containing treatment agent to the surface, wherein the agent further comprises at least one hydrolase chosen from glycosidases and/or proteases.

15. Method according to claim 14 wherein the at least one hydrolase is at least one or more glycosidases and the one or more glycosidases is hemicellulase and/or a starch-degrading enzyme.

16. Method according to claim 14 wherein the hydrolase is present in an amount of about 1:0.05 to about 1:20 by weight, based on the perfume ester.

17. Method of prolonging the fragrance effect of a perfume esters on a treated hard and/or soft surface comprising washing or cleaning the surface with perfume ester-containing washing or cleaning agents comprising hydrolases.

18. Method according to claim 17 wherein the agent is in liquid or solid form.

19. Method according to claim 17 wherein the hydrolase is present in an amount of from about 0.0000001 to about 5 wt. %, based on total agent.
